(19) United States
(12) Patent Application Publication
(10) Pub. No.: US 2011/0179736 A1
(43) Pub. Date: Jul. 28, 2011

(54) CONCRETE MATRIX STRUCTURE

(75) Inventor: Peter Waldron, Sheffield (GB)

(73) Assignee: CONSTRUCTION INNOVATION LIMITED, Sheffield (GB)

(21) Appl. No.: 13/054,379

(22) PCT Filed: Jul. 13, 2009
(86) PCT No.: PCT/GB09/50843

§ 371 Date: Apr. 12, 2011

(30) Foreign Application Priority Data
Jul. 14, 2008 (GB) 0812820.9

(51) Int. Cl. E04B 2/34; B28B 7/20; B28B 1/14; B29C 70/02; E04B 2/32; B65D 88/76

(52) U.S. Cl. 52/426; 249/101; 264/299; 264/241; 220/567.1

(57) ABSTRACT

A parallelepiped structure (10) comprises interleaved panels (12), each panel being moulded from concrete and being rectangular in plan and comprising a plurality of slots (22) along their top edges (16). The panels can be interleaved in order to provide the structure (10). Tongues (13) between adjacent slots (22) are supported on both sides against movement perpendicular to the plane of the panel (12) by ridges (24a,b) on the supporting panel, and so that the weakness inevitably constituted by them is mitigated. The structure (10) is suitable to accept vehicular loading, while the panels that make it up are still individually light enough to be manipulated by hand. The panels are moulded in moulds assembled from blow-or vacuum-moulded sheets placed together in a sandwich.

This invention relates to a matrix structure used in underground systems where substantial voids are required. Such structures are required in transportation and storage of fluids, and as passageways for the reception of cabling. Other applications are also feasible.

### BACKGROUND

It is well known to use plastic matrices of different construction in storm water drain-off tanks, where storm water can collect before being released slowly to the normal drainage run-off into streams and rivers. Such collection tanks counter-balance the increasing areas of concrete and tarmac in built-up areas that, with heavy rain-falls, precipitate flooding. They mimic the effect of absorbent earth that releases rain water to rivers more slowly and progressively. Nevertheless, by definition, such tanks are in built-up areas and indeed form part of such built up areas. Frequently they are under parking garages or car parks so that they are subject to loading from vehicles. Consequently, the matrices need to be strong. In the case of plastics, which is not a strong material, this means complex arrangements to maximise the structural rigidity. Nevertheless, it involves the use of considerable amounts of plastics material. For example, WTB Geotechnics manufacture a high void ratio matrix with high crushing strength, possibly as described in GB-A-2417733. Hoofmark manufacture a polypropylene matrix structure under the brand Raintank®, as do Polypipe Civils under the brand Polystorm, and Wavin Osma under the brand AquaCell.

Geoplast Elevetor® (www.geoproducts.ca) is a different arrangement assembled on site employing special caps seated on lengths of plastic drain pipe that form formwork for subsequently poured concrete.

In one respect, using, for example, recycled plastics material for this application would be a good means of disposing of waste plastics in an environmentally sound and in a useful way. However, given the structural requirement virgin plastics is generally always employed. Even as recycled waste, the use of such material for the present application is a waste of a valuable resource, and one which merely postpones the disposal problem for an, albeit lengthy, period of time. This is especially the case, however, with virgin plastics material. Even waste plastics material represents substantial energy, firstly (in what it represents in a waste format) as a source of fuel or hydrocarbons, but secondly in what it takes to make it in the first place. Thus to simply incorporate it into underground tanks, if alternative material could be employed, is, in fact, wasteful.

Concrete, on the other hand, would be much more suitable, because it takes relatively low energy to produce and, once formed, represents neither a valuable asset tied up in a low value application, nor a disposal problem waiting to happen. At the end of the lifetime of the tank, a concrete structure can simply be integrated with the rest of the rubble of a building site. Moreover, there would be no leaching out of chemicals into the ground water, which is a risk with plastics based matrices, particularly from recycled plastics.

However, while there is no fundamental problem in constructing concrete matrices, there are several difficulties therewith. The first is that concrete is much denser than plastics. Consequently, the costs of transportation of large cubic structures made of concrete, despite the fact that they will consist largely of void, will therefore be high—they are both large and heavy. Because they are heavy, their handling on site will need to be effected by machinery—cubic structures made of concrete will be too heavy for man-handling on-site. Secondly, moulding complex open structures from concrete is not especially easy because formwork has to have sufficient strength to resist the pressure of dense flowable concrete, and yet be removable from the final cast product.

U.S. Pat. No. 6,581,352 discloses a concrete panel employing an isogrid web. JP-A-10-68162 discloses I-section concrete elements that are connected together using special corner pieces to form the walls of multiple small cells for storm drainage.

It is an object of the present invention to provide a structure that does not have these aforementioned disadvantages, or at least mitigates their effects.

### BRIEF SUMMARY OF THE DISCLOSURE

In accordance with the present invention, there is provided a parallelepiped structure comprising interleaved panels, each panel being made from moulded concrete and being rectangular in plan and comprising front and back opposing sides, each with side edges, a base edge and a top edge,
wherein in each panel at least two slots are formed in the base edge parallel the side edges through from the front to back sides, which slots comprise two opposing side walls that extend from an open end of the slot in the base edge to a closed end of the slot, the length of the slots being at least half the distance between the top and bottom edges, and the slots being of a width at least as much as the thickness of the panel between the closed end and the top edge on a line parallel said side edges; and
wherein a ridge is formed between the closed end of each slot and the top edge on each side of said line, positioned so as to enclose the side walls of the slot of another identical panel when one of its slots is interleaved with a slot of a first panel, and so as to limit movement of the tongue between adjacent slots in one panel in a direction perpendicular to the sides of said one panel.

Preferably, there are N panels interleaved with M panels to form said structure, and wherein there are M slots in each of said N panels and N slots in each of said M panels. N and M may be the same and greater than 2.

The interleaved panels are preferably perpendicular to one another, the structure being cuboid.

Thus a structure according to the present invention, when assembled, comprises at least four panels, each with at least two slots, the four bottom edges being interleaved so that a parallelepiped structure is formed having a top and bottom surfaces formed by interleaved top and bottom edges of the four panels. The fundamental structure is familiar in the packaging industry where cardboard boxes are compartmentalised by cardboard panels of the basic structure defined above. Here, however, the same structure is modified by the ridges that give strength to each panel in the area thereof being “tongues” between adjacent slots in a direction transverse to the panel. It is here, in a direction perpendicular to the sides, that the panels are weakest and would be susceptible to failure if of the form as employed in such cardboard box dividers. In the present invention, the interleaving panels provide support for one another, the tongues of one panel being supported in the direction that the supporting panel is strongest (ie in its plane).

At least, this is the case if the panels are perpendicular to one another, which is their natural orientation. However, the slot walls could be inclined if desired, and the ridges shaped accordingly, so that the orientation between interleaved panels would not be perpendicular—the structure would be rhomboid. In that event, the support for the tongues would be better in one direction, ie towards the supporting panel, than in the other direction. If this orientation was employed, then possibly one ridge could be dispensed with (that one on the supporting side of the line), while the one on the other side might require modification to provide a re-entrant to support the tongue in the direction away from the supporting side. However, this depends on the extent of the inclination and the nature of the ridges.

The ridges could conceivably not comprise a discernable localised thickening of the panel on either side of said line. Instead, they could be in the form simply of a groove along said line. However, this is the same as a generalised thickening of the panel, which would be contrary to the general desire that the panels want to be strong enough for the purpose required, but as light as possible. Given that each panel has a through slot across at least half its height, a groove formed in each side surface for the panel, for the remaining height of the panel extending from the end of the slot to the top surface, is clearly a fundamental source of weakness of the panel. The remaining thickness between the opposing bases of the grooves must be sufficient to provide adequate strength to the panel, which means that a general thickening of the panel elsewhere is largely redundant. Nevertheless, the term “ridge” as used herein needs to include the possibility of being merely the sides of a groove formed along said line.

Preferably, however, said panel is as thin as it can be without losing structural integrity for its intended application. Given the fact that the panels are moulded, particularly if employing a method as described further below, it is feasible not only to mould the ridges mentioned above, but also to mould thickened edges of the panel around its entire periphery, thereby providing extra strength and permitting the panel to be correspondingly thinned.

Preferably, the panels have through holes that permit water and other things to communicate between the cells formed by the interleaving panels. Indeed, while the invention has so far been described in the context of the panels forming a storm water retention tank, it is also suitable for other purposes, such as for providing trunking routes for cables or drains or water or gas services.

A great advantage of the present invention is that the panels can be transported from their place of manufacture “flat-packed” so that their volume is efficiently small. On site, the structures can be assembled by hand, with each panel individually being easily manipulated by hand.

Preferably the slots are of a width w and are equally spaced from one another with a centre to centre separation of slots d so that the width D of the panel between its side edges is N*d or M*d, as the case may be. This provides half a width (d/2) of tongue and slot at the end of each panel, and that enables two panels to be butted end to end so that the size of the structure can be doubled, or more. This applies in both directions, of course. Preferably, if an enlarged structure is provided, the breaks between two adjacent pairs of panels are staggered so that the integrity of the overall structure is maintained and the inherent weakness caused by breaks between panels are mitigated.

Moreover, it is possible to enlarge such structure vertically, as well as horizontally, by stacking one structure on top of the other. Preferably, the panels are aligned one above the other so that the weight of structures above is taken by the entire length of each panel, both above and below, so that concentrated stresses are not imposed at points of contact between bridging panels suspended above supporting panels.

Preferably, the thickness t of the panel is between 7 and 15 mm thick, or preferably between 9 and 11 mm thick, or about 10 mm thick. The width w is preferably between 11 and 19 mm, more preferably between 13 and 15 mm, or about 14. Preferably there is between 2 and 6 mm difference between the thickness t of the panel and width w of slot 22, or about 4 mm. This same clearance also preferably exists between the abutting ridges of two interleaving panels.

In accordance with a different aspect of the present invention there is provided a method of constructing a panel for a structure as defined above. It is apparent from the foregoing description that the accuracy of manufacture of the panels is important. Great tolerance in the dimensions of the slots or ridges cannot be provided, otherwise the integrity of the overall structure will be compromised. However, if no tolerance is provided, and yet the manufacturing provides inaccuracies, then it is likely to be impossible to assemble the structure. Moulds formed from rigid metal, machined to great accuracy would provide the requisite assurance that the panels can be moulded with the accuracy needed. However, such moulds would be expensive for the purpose of forming the concrete panels themselves.

Accordingly, the present invention also provides a formwork comprising a plurality of form-sheets disposed in side by side relationship, each form-sheet having a form-side and a back-side and alternating in the direction they face, between facing form-sides of the form-sheets a form being defined in which to cast a panel as defined above, facing back-sides of adjacent form-sheets abutting one another in first and second regions, said first region being where the thickest parts of the panels to be cast are formed, and said second region being where an aperture in the panel to be cast is formed, said aperture being defined by rims having abutting form-sides and central bosses, extending from the base of said rims, whose back-sides abut the backsides of corresponding bosses on adjacent form-sheets.

Preferably, said first and second regions lie in a single plane.

Preferably, two form sheets are joined back-side to back-side in a pair, adjacent pairs defining a form between facing form-sides from each pair.

Preferably, said form-sheets are inserted in a close fitting box having ends and sides, the ends pressing said first regions towards one another.

Preferably, bolts extend through said formwork through a line of said bosses to clamp the sheets together, as well as to press said second regions towards one another.

In this way effective seals between adjacent sheets can be assured. Moreover, each sheet may be blow moulded, or vacuum moulded in a very inexpensive way and yet with sufficient accuracy on one face, which face is that which lies adjacent the mould of the blow or vacuum mould, and which preferably forms said front face of the sheet.

Preferably, the face of the form-sheet that lies adjacent the mould of the blow mould forms said form-side of the sheet.

Preferably, said sheets are all identical, being placed front to front and back to back with respect to one another, adjacent fronts forming the mould cavity of the form.

Preferably, a core is inserted after assembly of said formwork to mould said slot. The form-sheets may comprise longitudinal beads to locate the core when inserted, the core having corresponding grooves to engage with the beads. The core is preferably tapered to facilitate removal thereof from the slot when cured, said formwork providing a corresponding taper to the walls of the panel above the slot so that said wall is a snug fit in the slot when interleaved therewith.

In accordance with a different aspect of the present invention, a method of constructing a panel for a structure as defined above is provided, the method comprising the step of casting concrete in a formwork as defined above. Preferably, said concrete is first mixed with reinforcing fibres.

In accordance with another aspect of the present invention, a stormwater retention tank is provided comprising a structure as defined above or made in a formwork as defined above or made by a method as defined.

Indeed, in its broadest aspect, the present invention provides panels, each being one of the panels to construct a structure as defined above.

### BRIEF DESCRIPTION OF THE DRAWINGS

Embodiments of the invention are further described hereinafter, by way of example, with reference to the accompanying drawings, in which:

FIGS. 1a, b and c are, respectively, a side view of a panel forming a structure according to the present invention; a detail as indicated in FIG. 1a; and a section along the line A-A in FIG. 1a;

FIG. 2a and b are, respectively, a side view; and a section along the line A-A in FIG. 2a of a side sheet of a structure according to the present invention;

FIGS. 3a and b are, respectively, an exploded view of panels; and an assembled view of those panels, forming a different embodiment of a structure according to the present invention;

FIG. 4 is a side section through two interleaved panels according to the present invention;

FIGS. 5a to f are sections through the interleaving between panels according to different embodiments of the present invention;

FIGS. 6a, b and c are sections through form work according to the present invention, forming panels for making structures according to the present invention; and

FIG. 7 shows an enlarged structure according to the present invention.

### DETAILED DESCRIPTION

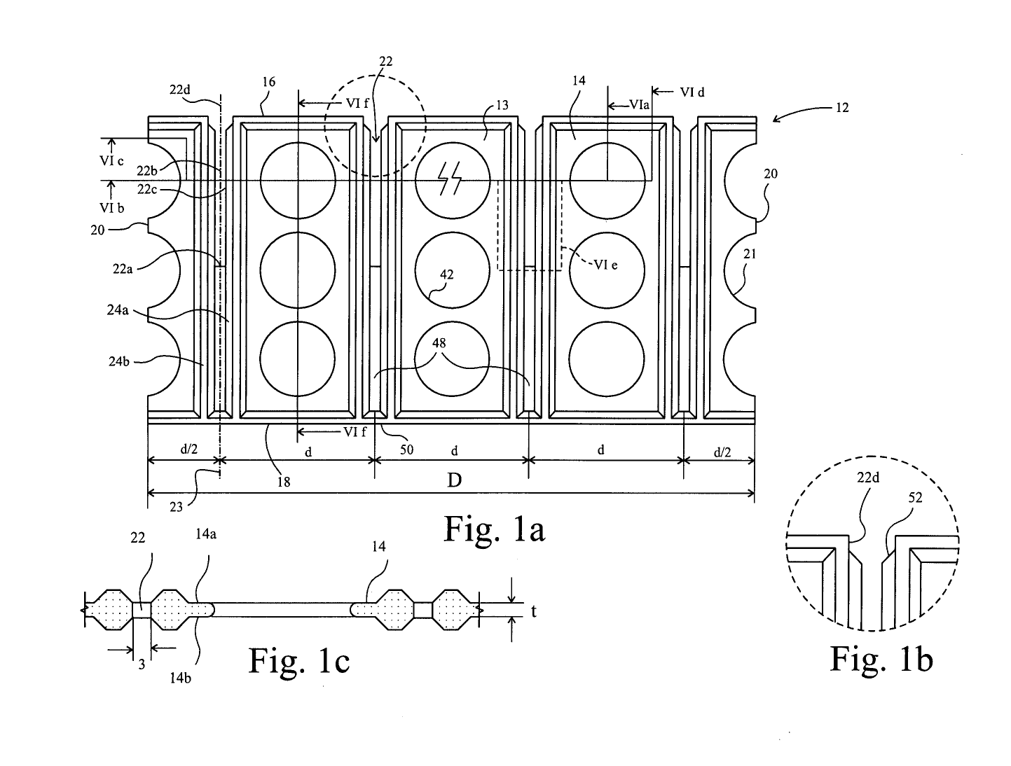

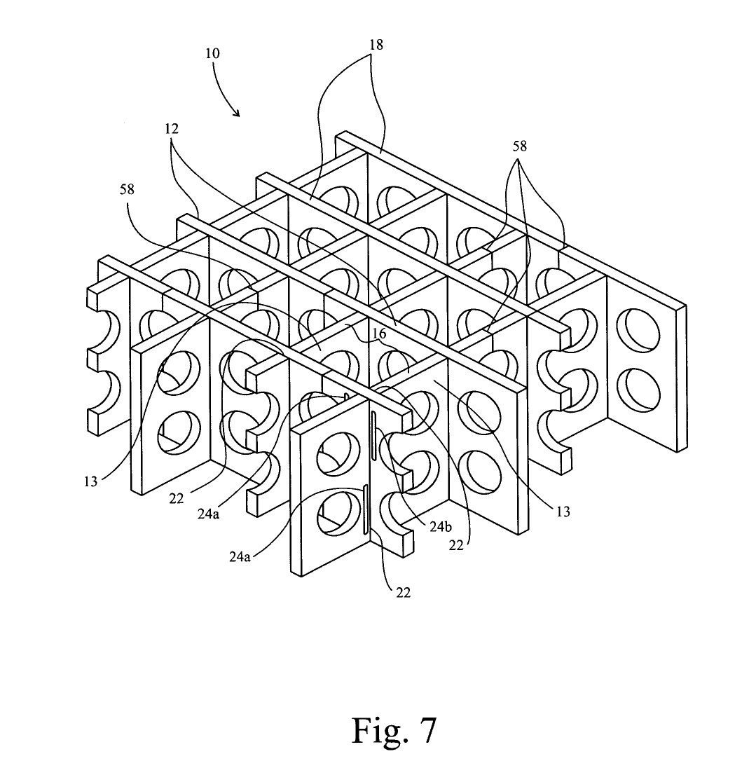

Referring first to FIG. 7, a structure 10 according to the present invention is made from a plurality of panels 12 interleaved together. An individual panel 12 is shown in side view in FIG. 1a, and comprises a thin flat panel sheet 14 having two sides 14a, 14b, a top edge 16, a bottom edge 18 and two side edges 20. The panel has a plurality of through slots 22 that extend from the top edge 16 to an end wall 22a disposed halfway between the top and bottom edges 16,18. The slot 22 is defined between side walls 22b,c of the slot and has a mouth 22d.

A ridge 24a,b is formed on either side of a line 23, the line being an extension of the centre line between the walls 22b,c of the slot 22. The ridges 24a,b extend for the entire height of the panel 12 between walls 16 and 18, although, depending on its geometry, may extend only from the slot end 22a to the bottom edge 18, as described further below.

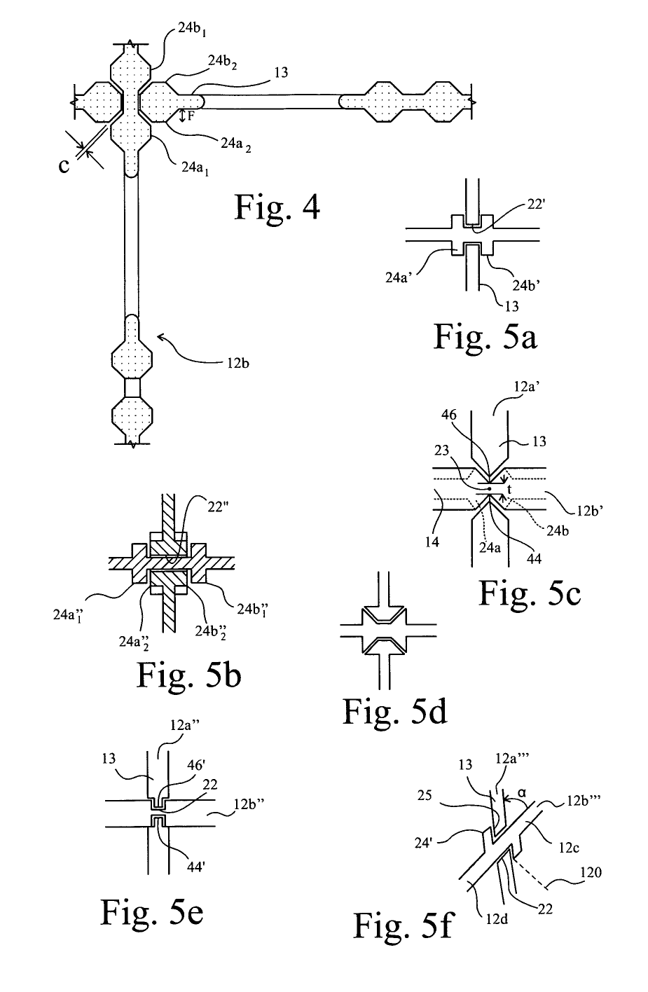

Two panels 12a,b (see FIG. 4) can be interleaved when the mouths 22d of two panels are engaged with one another and moved towards one another in the direction of the line 23, mutually engaging the slots 22 so that, when fully engaged, the panels form a cross, lying substantially in the same plane. In FIG. 4, it can be seen that ridges 24a₁ and 24b₁ of one panel 12b lie against the corresponding ridges 24a₂ and 24b₂ of the other panel 12a.

The problem overcome by the panel construction 12 is that, between adjacent slots 22, the tongues 13 formed thereby have very little strength in the direction perpendicular to the plane of the panel 13. Thus, in FIG. 4, tongue 13 is weak in the direction perpendicular to the plane of the panel 12a, indicated by the arrow F. However, engagement of the ridges 24a₁,a₂ and 24b₁,b₂ means that panel 12b acts as a supporting panel for the tongue 13 and prevents deflection of it perpendicular to the plane of the supported panel 12a.

From the foregoing, it is apparent that the shape of the ridges 24a,b can be varied without departing from this essential function. However, it should be appreciated that, in the case of the mitred arrangement shown in FIG. 4, the ridges 24a,b must extend the full height of the panel 12, since it is not just the ridges on the supporting panel 12b that result in support for the tongue 13 on the supported panel 12a, but that the ridges adjacent the slot are also needed.

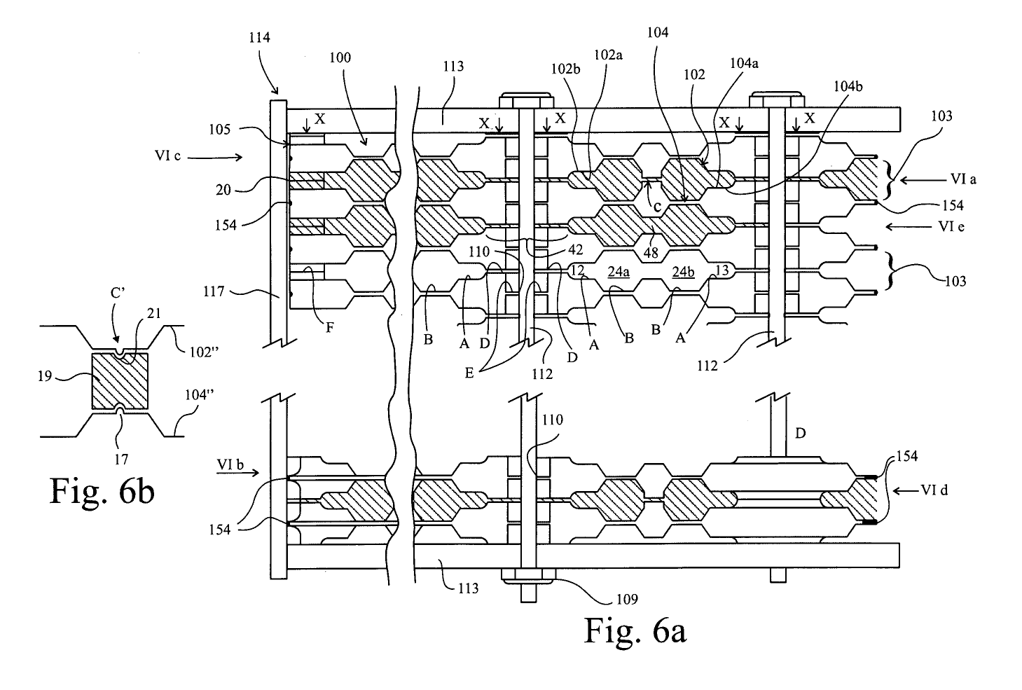

However, in FIG. 5a, instead of being mitred, and part of the ridge being also adjacent the slot 22, the ridges 24a′, 24b′ are rectangular, so that the tongue 13 is still supported in a direction perpendicular to its plane, despite the absence of any ridges adjacent the slot. That is, the ridges 24a′,24b′ only extend in the region beyond the slot, between the slot end 22a and the bottom edge 18. Indeed, they serve only to strengthen the panel where it least needs it (beyond, of course, its support for the tongue of an interleaving panel). This is why the arrangement of FIG. 4 is preferred, because the ridge extending from edge to edge increases the strength of the panel and enables the remainder of sides 14 to be relatively thin. Indeed, they can, and are, provided with large apertures 42, without undermining the strength of the panel.

Nevertheless, the arrangement shown in FIG. 5a is feasible, as indeed is the arrangement in FIG. 5b. This arrangement is preferable to that shown in FIG. 5a, since there is reinforcement of the panel sides from top 16 to bottom 18, with a flange 24a₂″, 24b₂″ being provided down the side of the slot 22″ to cooperate with the ridges 24a₁″, 24b₁″. However, there is still a disadvantage with this arrangement in that there is a transition between the ridge forms 24a₁″, 24b₁″ and the flanges 24a₂″, 24b₂″ at the slot end 22a. This inevitably has an adverse effect on the strength of the panel.

In FIG. 5c is shown an arrangement in which the ridges 24a,24b are not evident at all. However, this is only because the panel sides 14 have been given the same thickness as the ridges. There is still support for the tongue 13 of the panel 12a in the direction perpendicular to the panel 12a since the slot walls extend into the grooves 44,46 formed in the panel 12b′. Nevertheless, there would, in reality, be little purpose in the arrangement shown in FIG. 5c. The thickness t between grooves 44, 46 in the panel 12b determines the strength of the panel. Accordingly, the excessive thickness of the sides 14 away from the line 23 is entirely superfluous. This merely renders the panel heavier, and using of more material, than is necessary.

FIG. 5d is a development of the preferred arrangement shown in FIG. 4, where the ridges have been reduced to their minimum, but while otherwise maintaining the functionality shown in FIG. 4.

In FIG. 5e, the arrangement is similar to that shown in FIG. 5c, but here with a square cut to the grooves 44′,46′. This arrangement is slightly advantageous over that shown in FIG. 5c in that tendency for the tongues 13 to move in a direction perpendicular to the panel 12a does not result in any spreading of the slot 22, which inevitably occurs with the mitred arrangement of FIG. 5c.

Finally, FIG. 5f shows an arrangement in which the panels 12a″′,b′″ are not perpendicular to one another, as in the embodiments described above, but are at an angle α, which may be as little as 45 degrees. In this arrangement, the supporting panel 12b″′ has a supporting side 12c on one side of the normal 120 to the panel 12b″′, and an unsupporting side 12d on the other side of line 120. Only on the unsupporting side 12d is a ridge 24′ required, the ridge on the other side being integrated into the supporting side 12c itself. That is, tendency of the tongue 13 to move perpendicularly to its plane is restrained by the supporting side 12c itself. However, on the unsupporting side, the ridge 24 needs to provide a re-entrant 25 under which the wall of the slot 22 can “hook” to prevent its movement in the direction of the normal to the panel 12a″′.

Turning to FIG. 1a again, it can be seen that the ridges 24a,b extend between the top edge 16 and bottom edge 18. However, it also extends around the top edge 16 and bottom edge 18 to complete a frame that gives substantial rigidity to the panel and helps support the tongue 13. The weakness of the system is the joining wall 48, which can only be as thick as the slot 22 is wide (less clearance). However, at its base 50, the ridge extends between adjoining sections of the panel 12 again, substantially improving the overall strength of the arrangement. This means that the mouth 22d (see FIG. 1b) is stepped inwardly at 52 in order to accommodate the base 50. Thus, the wall 58 and accompanying ridges 24a, b and base 50 fill the gap provided by slot 22 and its mouth 52. Accordingly, there is little space for movement when two panels are joined in a cross and their combined strength and rigidity is substantial.

The overall width D of the panel 12 may be 900 mm. In the embodiment shown in FIG. 1a the number N of slots is 4. The separation n between each slot is equal to D/n, which in the case of FIG. 1a, is 225 mm. In the embodiment shown in FIGS. 1a and 4, the thickness t of the panel is 10 mm and the width w of the slot is 14 mm, providing 2 mm clearance c on either side. Indeed, the clearance c is extended to between the ridges 24a₁,24a₂ and 24b₁,24b₂

The distance between the last slot and the edge 20 is d/2. Accordingly, when two panels 12 are placed end to end the separation between two slots separated by a break between two ends 20 is the same as the separation between slots of a panel 12. Thus, turning to FIG. 7, panels 12 can be butted end to end, forming part of a larger structure 10 than merely as many panels as there are slots. Indeed, if the breaks 58 between adjacent panels are staggered with respect to one another (substantially as shown in FIG. 7) then the weakness in the overall structure, constituted by such breaks, can be minimised and spread over the entire structure.

It will be appreciated that panels running in one direction have their top edges 16 uppermost while those running in the other direction will have their bottom edges 18 uppermost. Accordingly, the top and bottom edges are substantially identical so that a planar surface is formed by the top and bottom edges, which is flat and contiguous. Thus, the structure 10 will stand evenly on a flat floor. Similarly, concrete lids or flagstones can be placed directly on the structure 10.

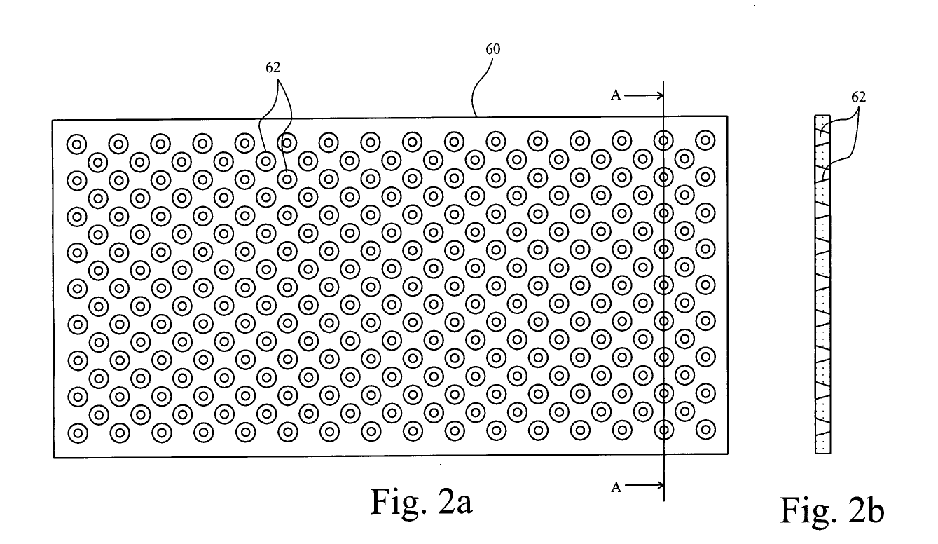

The structure 10 so formed provides a useful storage tank for rain water drainage (eg a soakaway). The sides of the tank may be formed by panels 60 as shown in FIG. 2a and b. The panels 60 comprise a plurality of tapered apertures 62 through which water filters on entering or leaving the structure 10, thereby preventing the structure 10 from becoming clogged by larger debris. The holes 62 prevent ingression of large stones. A fabric sheet can be attached to stop fines from entering. Alternatively, the tank may be fed from drains and roof gutters by one or more pipes, and water collected in the tank 10 is able to seep out gradually into the surrounding ground through the holes 62.

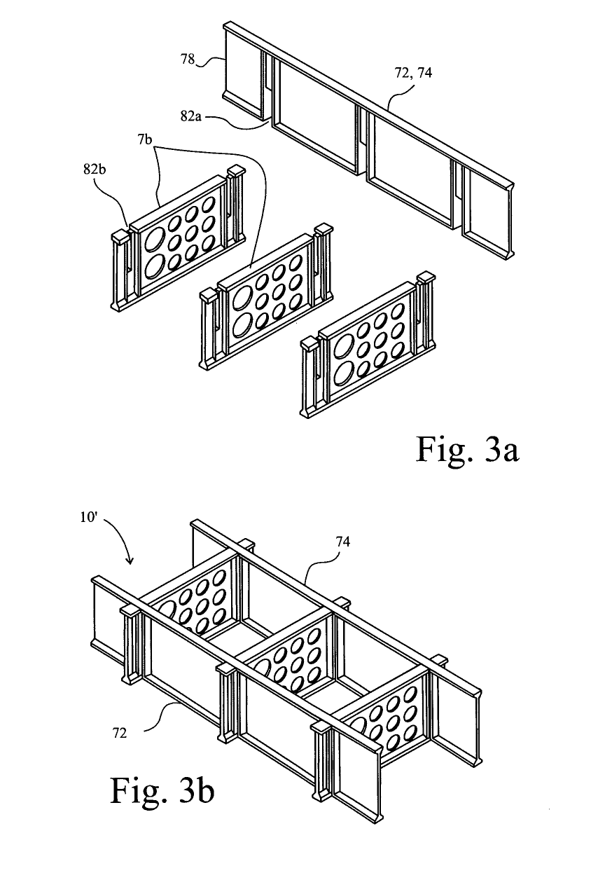

Turning to FIGS. 3a and b, a structure 10′ is illustrated which employs the same principles as the present invention, but wherein the panels in different directions are different. Two side panels 72,74 are provided, and several intervening cross panels 76. Again, if the length of one side panel 72,74 is insufficient for the application under consideration, then numerous panels 72,74 can be butted end to end and their ends 78 can be staggered with respect to each other. The side panels 72,74 are provided with slots 82a and the cross panels 76 are likewise provided with corresponding slots 82b. Accordingly, side panels 72,74 and cross panels 76 can be interleaved as shown in FIG. 3a to form an overall structure that is suitable as a conduit chamber for services such as water, gas, electricity and telecommunications conduits.

Manufacture of the panels 72,74 and 76 of the FIG. 3 arrangement, and panels 12 of the FIGS. 1 and 7 arrangement, is by casting concrete, for example glass reinforced concrete, into appropriately shaped moulds.

It is a further aspect of the invention to provide a mould constructed from a plurality of blow-moulded plastics sheets 102,104, which are advantageously identical with one another and which act together, in pairs, to form mould forms 103. Each form 103 comprises the form-sides 102a,104a of the form sheets 102,104. Forms 103 are positioned next to each other in a “box” 114 with their back-sides 102b,104b (opposite to those of the form-sides 102a,104a) facing and abutting one another.

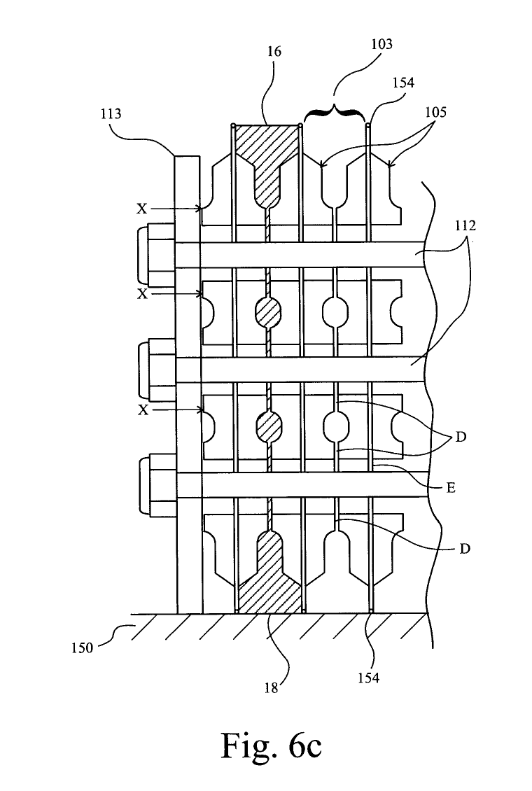

The void formed by the form 103 into which concrete is cast is indicated by hashed lines in FIG. 6a and c, which are respectively horizontal and vertical sections through the mould where it is forming the panel 12 along the line VIa/d-VIb/d and VIf-VIf in FIG. 1a. That is to say, in the top of FIG. 6a, in the direction of the arrows VIa and VIc, the section is along the line VIa-VIc in FIG. 1a. In the top right and bottom left of FIG. 6a, in the direction of the arrows VIa and VIb, the section is along the line VIa-VIb in FIG. 1a. In the bottom right and top left of FIG. 6a, in the direction of the arrows VId and VIc, the section is along the line VId-VIc in FIG. 1a. In the bottom of FIG. 6a, in the direction of the arrows VId and VIb, the section is along the line VId-VIb in FIG. 1a. FIG. 6c is a section along the line VIf-VIf in FIG. 1a.

The sheets 102,104 have the following regions:
regions A, that forms the skin or web thickness of the tongue 13 and side generally of the panel 12;
regions B, that form the ridges 24a,b;
a lip C, that is pressed against the corresponding lip of the other sheet so that the gap between the ridges 24a,b is closed, thereby forming the slot 22. However, also shown in FIG. 6a is the wall 48 formed lower down the panel (see line VIe in FIG. 1a) that corresponds with the view direction VIe in FIG. 6a);
a rim D, that is provided to create the apertures 42. However, the rims D do not extend right across the aperture 52, but, instead, they have:
central bosses E, that extend out of the plane of the aperture 42. Holes 110 extend through the centre of the bosses E, through which a bolt 112 can be passed; and finally,
rims F that form the scallops 21 in the side edge 20.

Thus a plurality of sheets 102,104 are stacked together and clamped by the bolts 112. The bolts 112 also pass through end walls 113 of the box 114 and, when nuts 109 are tightened, the walls 113 press all the sheets 102,104 against one another, ensuring that the gaps between facing form-sides where they are intended to close the form to prevent ingress of the concrete (at regions C and D) to form the slot 22 and apertures 42. Not all the apertures 42 require the bolts.

Preferably, the back-sides of 102b,104b of two for sheets 102,104 are physically connected together around their periphery 154 to form single units 105 each forming one side of two adjacent forms 103, except for the unit that lies against the end walls 113, which is not, therefore employed other than to provide reaction surfaces X in a single plane.

Once the form-work is assembled and bolts 1112,109 tightened, concrete is poured into the open tops of the mould forms 103. The concrete percolates down and sits on base 150 on which the form-work is assembled, forming there the bottom edges 18 of the panel 12. It also percolates sideways and is retained by side walls 117, forming there the side edges 20 of the panels 12. Once filled, the top surface of the concrete form the top edge 16 of the panel 12.

Once the concrete has set, the bolts 112 are released, the sides 113 and 117 removed, and the mould forms separated to expose the cast panels 12.

A preferred alternative to the lip C shown in FIG. 6a is shown at C′ in FIG. 6b. Here, the wall-48-forming profile of the sheets 102,104 is maintained into the region where the slot 22 is required, except that a thin, longitudinal bead 17 is provided down the length of the slot form. When the sheets are stacked together as described above, and before pouring the concrete, a core 19 is inserted between sheet 102″,104″. The core 19 has grooves 21 that correspond with and locate on the bead 17. This facilitates separation of the mould since this would otherwise be hindered by the lip C being caught in the formed slot 22. With the arrangement of FIG. 6b, there is no problem of mould separation, and the cores can be extracted easily from the slots 22, especially if the core has a slight taper from top edge 16 to slot end 22a. The wall 48 can, of course, be given a corresponding taper so that it fits snugly in the tapered slot 22.

As already mentioned, sheets 102,104 are preferably identical. Moreover, the form-face 102a,104a of each sheet 102,104 (that defines the form for each panel 12) is that face of the blow moulded sheet 102,104 that lies against the blow mould when the sheet is formed. Therefore, this surface has the precision of the mould, so that the surface details of the panel 12, when formed, are precise. While the form sheets 102,104 are clearly capable of deflection, and therefore of producing misshapen panels, the use of the bolts 112, and fitting an appropriate number in a retaining box 114, means that the dimensions and overall shape of the panel is accurate and enabling the panels to be joined as described above and to form strong and rigid structures.

In the event that the mould form sheets 102,104 are identical, the bosses E are of equal height, and meet one another in the same plane as the ridges 24a,b. However, it is not essential that they be identical; the bosses E could be of different height, but there seems little point in deliberately making sheets 102,104 different. Certainly, doing that does not affect their operation.

Although blow-moulded plastics sheets are convenient, the invention is not limited to their use. For example, pressed steel sheet would be perfectly acceptable. Also, the combined reverse pair 105 of sheets could be a solid injection moulding or two castings of resin.

Thus, by virtue of the present invention the panels 12 can conveniently be made. Once made, they can be transported easily and efficiently by being flat-packed and carried to site. Individual panels are easily manipulated by operators at the site, assembling the structure 10 as desired. The strength of the assembled structure is adequate to take a vehicle loading. Indeed, using glass reinforced concrete and the dimensions mentioned above, a loading of 150 tonnes per square meter can be accommodated.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A parallelepiped structure comprising interleaved panels, each panel being made from moulded concrete and being rectangular in plan and comprising front and back opposing sides, each with side edges, a base edge and a top edge, wherein in each panel at least two slots are formed in the base edge parallel the side edges through from the front to back sides, which slots comprise two opposing side walls that extend from an open end of the slot in the base edge to a closed end of the slot, the length of the slots being at least half the distance between the top and bottom edges, and the slots being of a width at least as much as the thickness of the panel between the closed end and the top edge on a line parallel said side edges; and wherein a ridge is formed between the closed end of each slot and the top edge on each side of said line, positioned so as to enclose the side walls of the slot of another identical panel when one of its slots is interleaved with a slot of a first panel, and so as to limit movement of the tongue between adjacent slots in one panel in a direction perpendicular to the sides of said one panel.

2. A structure as claimed in claim 1, in which there are N panels interleaved with M panels to form said structure, and wherein there are M slots in each of said N panels and N slots in each of said M panels.

3. A structure as claimed in claim 1, wherein N and M are the same and greater than 2.

4. A structure as claimed in claim 1, in which interleaved panels are perpendicular to one another, the structure being cuboid.

5. A structure as claimed in claim 1, in which interleaved panels are inclined to one another, the structure being rhomboid.

6. A structure as claimed in claim 5, wherein the ridge supporting the tongue of said one panel is integral with the supporting panel on a supporting side of said line, while the one on the other side the ridge is undercut to provide a re-entrant to support the tongue in the direction away from the supporting side.

7. A structure as claimed in claim 1, wherein the ridges do not comprise a discernable localised thickening of the panel on either side of said line.

8. A structure as claimed in claim 1, in which said panel is as thin as it can be without losing structural integrity for its intended application.

9. A structure as claimed in claim 5, wherein the panel has thickened edges around its entire periphery, thereby providing extra strength and permitting the panel to be correspondingly thinned.

10. A structure as claimed in claim 1, in which the panels have through holes between said slots and/or between said ridges that permit fluid communication from one side of a panel to the other.

11. A structure as claimed in claim 3, wherein the slots are of a width w and are equally spaced from one another with a centre to centre separation of the slots of d where the width D of the panel between its side edges is N*d or M*d, as the case may be.

12. A structure as claimed in claim 11 , wherein each panel has half a width (d/2) of tongue and slot at each end thereof.

13. A structure as claimed in claim 12, wherein an enlarged structure is provided with panels being butted end to end.

14. A structure as claimed in claim 13, wherein the breaks between two adjacent pairs of panels are staggered so that the integrity of the overall structure is maintained and the inherent weakness caused by breaks between panels are mitigated.

15. A formwork comprising a plurality of form-sheets disposed in side by side relationship, each form-sheet having a form-side and a back-side and alternating in the direction they face, between facing form-sides of the form-sheets a form being defined in which to cast a panel as claimed in claim 1, facing back-sides of adjacent form-sheets abutting one another in first and second regions, said first region being where the thickest parts of the panels to be cast are formed, and said second region being where an aperture in the panel to be cast is formed, said aperture being defined by rims having abutting form-sides and central bosses, extending from the base of said rims, whose back-sides abut the backsides of corresponding bosses on adjacent form-sheets.

16. A formwork as claimed in claim 15, wherein said first and second regions lie in a single plane.

17. A formwork as claimed in claim 15, wherein two form sheets are joined back-side to back-side in a pair, adjacent pairs defining a form between facing form-sides from each pair.

18. A formwork as claimed in claim 15, wherein said form-sheets are inserted in a close fitting box having ends and sides, the ends pressing said first regions towards one another.

19. A formwork as claimed in claim 15, wherein bolts extend through said formwork through a line of said bosses to clamp the sheets together, as well as to press said second regions towards one another.

20. A formwork as claimed in claim 18, wherein bolts extend through said formwork through a line of said bosses to clamp the sheets together, as well as to press said second regions towards one another and wherein said bolts pass through opposing ends of the box and the ends squeeze the form-sheets towards one another when tightened.

21. A formwork as claimed in claim 15, wherein said form-sheets are blow moulded plastics.

22. A formwork as claimed in claim 21, wherein the face of the form-sheet that lies adjacent the mould of the blow mould forms said form-side of the sheet.

23. A formwork as claimed in claim 15, wherein a core is inserted after assembly of said formwork to mould said slot.

24. A formwork as claimed in claim 23, wherein the form-sheets comprise longitudinal beads to locate the core when inserted, the core having corresponding grooves to engage with the beads.

25. A formwork as claimed in claim 23, wherein the core is tapered to facilitate removal thereof from the slot when cured, said formwork providing a corresponding taper to the walls of the panel above the slot so that said wall is a snug fit in the slot when interleaved therewith.

26. A formwork as claimed in claim 18, wherein the form is closed at least partly at its sides and base by the sides and floor of said box.

27. A method of constructing a panel for a parallelpiped structure, comprising interleaved panels, each panel being made from moulded concrete and being rectangular in plan and comprising front and back opposing sides, each with side edges, a base edge and a top edge,
wherein in each panel at least two slots are formed in the base edge parallel the side edges through from the front to back sides, which slots comprise two opposing side walls that extend from an open end of the slot in the base edge to a closed end of the slot, the length of the slots being at least half the distance between the top and bottom edges, and the slots being of a width at least as much as the thickness of the panel between the closed end and the top edge on a line parallel said side edges; and
wherein a ridge is formed between the closed end of each slot and the top edge on each side of said line, positioned so as to enclose the side walls of the slot of another identical panel when one of its slots is interleaved with a slot of a first panel, and so as to limit movement of the tongue between adjacent slots in one panel in a direction perpendicular to the sides of said one panel, said method comprising the step of casting concrete in a formwork as claimed in claim 15.

28. A method as claimed in claim 27, wherein said concrete is first mixed with reinforcing fibres.

29. A stormwater retention tank comprising a structure as claimed in claim 1.

30. A stormwater retention tank as claimed in claim 29 comprising sides having tapered holes.

31. A panel being one of the panels to construct a structure as claimed in claim 1.

32. (canceled)

33. A stormwater retention tank comprising a structure made in a formwork as claimed in claim 15.
